(19) United States
(12) Patent Application Publication
(10) Pub. No.: US 2012/0108264 A1
(43) Pub. Date: May 3, 2012

(54) Monitoring And Apparatus For Monitoring Cellular Network Coverage Using Mobile Units

(76) Inventors: KEVIN S. MARTZ, WHEATON, IL (US); JITIN C. PARIKH, NAPERVILLE, IL (US)

(21) Appl. No.: 12/915,192

(22) Filed: Oct. 29, 2010

(51) Int. Cl. H04W 24/02

(52) U.S. Cl. 455/456.2

(57) ABSTRACT

Low signal strength areas in a communication system are identified utilizing a mobile unit. The mobile unit receives a first signal. If the first signal falls below a predetermined signal strength threshold the mobile unit determines and stores its geographic location. Upon receiving a second signal that exceeds the predetermined signal strength threshold the mobile unit sends the geographic location to the second base station.

### FIELD OF THE INVENTION

The present invention relates generally to communication systems, and more particularly to cellular network coverage.

### BACKGROUND OF THE INVENTION

Cellular service providers provide cellular service to subscribers over a wide-ranging coverage area. This service is provided by installing multiple base stations within the coverage area, each base station providing communication within a cell. Each base station sends and receives over-the-air signals to mobile units within their cell.

Cells generally overlap so that mobile units do not lose coverage when moving within the coverage area from one cell to another.

One common problem in cellular networks is dropped calls, which occur when a mobile unit engaged in communication loses the signal from the base station to which it had been communicating. This can occur due to a poor network plan, equipment malfunction, or intermittent weather conditions.

In addition, cellular service providers manage their networks by splitting cells with multiple base stations or adding additional base stations. The impact of these actions has an effect on the coverage provided, and the service provider requires knowledge of the impact on the quality of their network.

In current cellular systems, service providers detect coverage holes by monitoring dropped calls, logging customer complaints, or having technicians move through the cellular system measuring signal strength. Each of these methods has significant drawbacks. Dropped calls are not always the result of moving out of cell coverage, and it is not always possible to determine an accurate location of a cell boundary. Customers do not always complain about dropped calls, and when they do they typically do not provide an accurate location description. Technicians provide a more accurate testing but are expensive.

Therefore, a need exists for a method to simply and accurately determine coverage holes in a cellular communication system.

### BRIEF SUMMARY OF THE INVENTION

Mobile units, such as GPS enabled smart phones, are updated to detect low signal-strength and/or loss of service for both voice and data, and record the location of the event. Once service is restored, the mobile unit sends a message containing the event to a Cellular Coverage Monitor. The Cellular Coverage Monitor correlates the event with data from the MSC and displays a map showing a service provider's network coverage.

The coverage data can be used by the service provider for planning extensions to the cellular network. The area with the highest number of customers losing service could be expanded first. The coverage data could also alert the service provider to unexpected loss of service.

### BRIEF DESCRIPTION OF THE SEVERAL VIEWS OF THE DRAWINGS

FIG. 1 depicts a portion of a communication system in accordance with an exemplary embodiment of the present invention.

FIG. 2 depicts a flowchart of the patentable process that occurs meaningfully within various physical devices within communication system in accordance with an exemplary embodiment of the present invention.

### DETAILED DESCRIPTION OF THE INVENTION

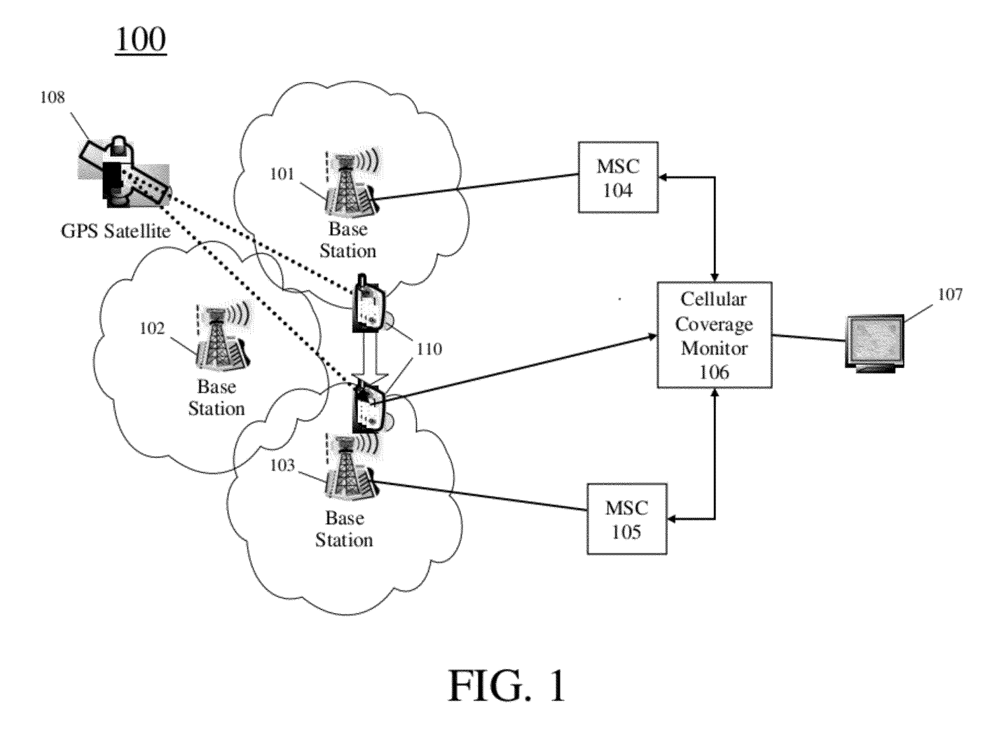

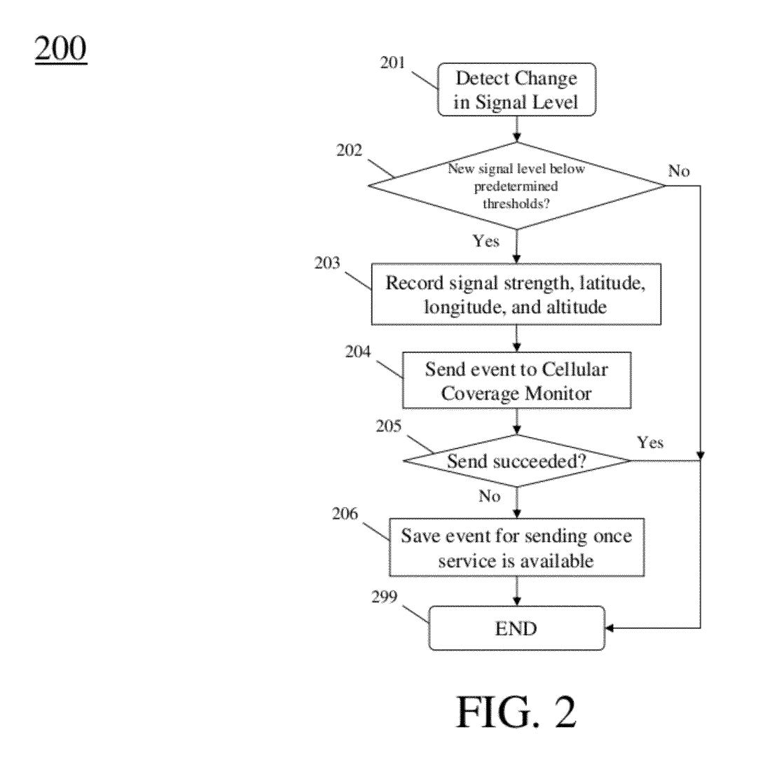

An exemplary embodiment of the present invention can be better understood with reference to FIGS. 1 and 2. FIG. 1 depicts a portion 100 of a communication system in accordance with an exemplary embodiment of the present invention. Portion 100 includes three base stations, base station 101, base station 102, and base station 103, two Mobile Switching Centers (MSC), MSC 104 and MSC 105, a cellular coverage monitor 106, and a Service Coverage Display 107. Portion 100 communicates with mobile unit 110 and GPS satellite 108.

In an exemplary embodiment, base stations 101, 102, and 103 are CDMA base stations and MSC 104 and MSC 105 are CDMA MSCs. MSC 104 and MSC 105 control base stations 101, 102, and 103. It should be understood that a typical communication system includes more than three base stations and two mobile switching centers, but these amounts are shown for clarity.

Cellular coverage monitor (CCM) 106 is a computer that is able to receive location and service data from mobile unit 110, preferably via an SMS message. Alternately CCM 106 receives the location and service data via a message sent via a base station and an MSC. CCM 106 also includes a processor for processing and correlating data received, memory for storing data, and an output port for outputting data. CCM 106 can be a stand-alone unit or could be included in an MSC or an NOC (Network Operations Center).

Service Coverage Display (SCD) 107 is an output device that displays, preferably via a graphical user interface, data from CCM 106. SCD 107 can be a monitor or the like. SCD 107 can be a stand-alone unit or can be incorporated into CCM 106.

GPS satellite 108 depicts one of several space-based global navigation satellite system that provides reliable location and time information anywhere on or near the Earth. Although only one satellite is depicted for clarity, the GPS system includes a plurality of satellites and a user needs to have an unobstructed line of sight to four or more GPS satellites.

In accordance with an exemplary embodiment, mobile unit 110 is GPS-enabled. At a first time mobile unit 110 is located within the coverage area of base station 101. At a second time mobile unit 110 is located within the coverage area of base station 103.

In the exemplary embodiment depicted in FIG. 1, as mobile unit 110 leaves the coverage area of base station 101, mobile unit 110 detects that it has lost the service of base station 101. Upon detecting this loss of service, mobile unit 110 determines and stores its current location. In an exemplary embodiment, the current location is determined using GPS and includes the latitude, longitude, and altitude of mobile station 110 at the time it lost service. Mobile unit 110 can determine and store this location data for voice service and alternately for data service.

Upon recovering service, in this exemplary embodiment when mobile unit 110 enters the coverage area of base station 103 and has adequate cellular service, mobile unit 110 sends the location data to cellular coverage monitor 106. In an exemplary embodiment, mobile unit 110 sends the location data via a loss of service event and sends the loss of service event to cellular coverage monitor 106 via base station 103 and MSC 105.

In an exemplary embodiment, cellular coverage monitor 106 queries MSC 104 and MSC 105 for mobile unit data to correlate the service loss. CCM 106 can use the location data to determine which MSC is associated with a particular location and use that information to determine which MSC to query.

After correlating with MSC location data and other service loss events, cellular coverage monitor 106 updates service coverage display 107.

FIG. 2 depicts a flowchart of the patentable process that occurs meaningfully within various physical devices within communication system 100. In accordance with an exemplary embodiment, mobile unit 110 is a smart phone that can be dynamically updated with an updateable list of service thresholds. Each threshold preferably includes a service type and a signal strength. In an exemplary embodiment, the service type is either voice or data.

Mobile unit 110 detects (201) a change in the received signal level. In accordance with an exemplary embodiment, the signal level relates to the signal received by mobile unit 110 from base station 101.

Upon detecting a change in signal strength, mobile unit 110 determines (202) if the new signal level is below a predetermined threshold. If the new signal level does not fall below the predetermined threshold, the process ends (299).

If the new signal does fall below the predetermined threshold as determined at step 202, mobile unit 110 records (203) signal strength measurements and location parameters. In an exemplary embodiment, the location parameters include the latitude, longitude, and altitude of mobile station 110 when it received the new signal.

In an exemplary embodiment, mobile unit 110 received the new signal and the new signal fell below a predetermined threshold. The predetermined threshold is set at a level of inadequate service. For example, it can be set at a level of lower than acceptable service. Alternately, the predetermined threshold can be set at a level where service is interrupted and a call or data session is ended.

Upon receiving acceptable service, mobile unit 110 sends (204) the signal strength measurements and the location parameters to Cellular Coverage Monitor 106. In an exemplary embodiment, mobile unit 110 sends an event to Cellular Coverage Monitor 106, and the event includes the signal strength measurements and the location parameters.

If it is determined (205) that the sending succeed at step 204, the process ends (299). If the sending did not succeed at step 204, mobile unit 110 saves (206) the event for sending at a later time. In an exemplary embodiment, the sending is done when service is available to mobile unit 110.

An exemplary embodiment of the present invention thereby provides a low-cost and accurate way of mapping service levels in a cellular network and will provide the service provider an automatic way of monitoring the quality of its network. It will show the service provider where to expand its network and where unexpected problems exist. This is accomplished without requiring drive testing, which if performed on the entire network would be very expensive. This solution is better than tracking dropped calls or customer complaints, because it detects service levels even when not in a call and provides accurate location. This solution provides thousands of data points at minimal cost to the service provider.

While this invention has been described in terms of certain examples thereof, it is not intended that it be limited to the above description, but rather only to the extent set forth in the claims that follow.

We claim:

1. A method for defining low signal strength areas in a communication system utilizing a mobile unit, the method comprising:
receiving a first signal at a mobile unit from a first base station;
determining at the mobile unit that the first signal falls below a predetermined signal strength threshold;
determining the geographic location of the mobile unit;
storing the geographic location of the mobile unit in the mobile unit;
receiving a second signal from a second base station, the second signal exceeding the predetermined signal strength threshold; and
sending the geographic location from the mobile unit to a cellular coverage monitor.

2. A method for defining low signal strength areas in a communication system utilizing a mobile unit in accordance with claim 1, wherein the geographic location comprises the latitude and longitude of the mobile unit.

3. A method for defining low signal strength areas in a communication system utilizing a mobile unit in accordance with claim 1, wherein the geographic location comprises the altitude of the mobile unit.

4. A method for defining low signal strength areas in a communication system utilizing a mobile unit in accordance with claim 1, wherein the step of sending the geographic location of the mobile unit to the cellular coverage monitor comprises sending the location of the mobile unit via a loss of service event.

5. A method for determining a low signal strength area, the method comprising:
receiving at a cellular coverage monitor a plurality of low signal strength messages, each of the plurality of low signal strength messages including a location; and
defining a low signal strength area at the cellular coverage monitor by correlating the locations of at least a portion of the plurality low signal strength messages.

6. A method for determining a low signal strength area in accordance with claim 5, wherein the step of defining a low signal strength area at the cellular coverage monitor comprises querying a plurality of Mobile Switching Centers.

7. A method for determining a low signal strength area in accordance with 6, wherein the cellular coverage monitor utilizes the location to determine which MSC to query.

8. A method for determining a low signal strength area in accordance with claim 5, the method further comprising the step of updating a display on the cellular coverage monitor based upon the low signal strength area.

9. A method for detecting a change in a received signal level at a mobile unit, the method comprising:
receiving at a mobile unit a first signal that falls below a predetermined threshold;
storing signal strength measurements and location parameters at the mobile unit; and
upon receiving a second signal that exceeds the predetermined threshold sending the signal strength measurements and the location parameters to a Cellular Coverage Monitor.

10. A method for detecting a change in a received signal level at a mobile unit in accordance with claim 9, wherein the location parameters include the latitude and longitude of the mobile unit.

11. A method for detecting a change in a received signal level at a mobile unit in accordance with claim 9, wherein the predetermined threshold is set at a level of inadequate service.

12. A method for detecting a change in a received signal level at a mobile unit in accordance with claim 9, wherein the predetermined threshold is set at a level of service interruption.

13. A method for detecting a change in a received signal level at a mobile unit in accordance with claim 9, wherein the step of sending the signal strength measurements to a Cellular Coverage Monitor comprises sending an event to the Cellular Coverage Monitor.

14. A method for detecting a change in a received signal level at a mobile unit in accordance with claim 13, wherein the event includes signal strength measurements.

15. A method for detecting a change in a received signal level at a mobile unit in accordance with claim 13, wherein the event includes location parameters.

16. A method for detecting a change in a received signal level at a mobile unit in accordance with claim 9, the method further comprising the step of dynamically updating the predetermined threshold at the mobile unit.

17. A method for detecting a change in a received signal level at a mobile unit in accordance with claim 16, wherein the predetermined threshold comprises a service type.

18. A method for detecting a change in a received signal level at a mobile unit in accordance with claim 17, wherein the service type is voice.

19. A method for detecting a change in a received signal level at a mobile unit in accordance with claim 17, wherein the service type is data.

20. A method for detecting a change in a received signal level at a mobile unit in accordance with claim 16, wherein the predetermined threshold comprises signal strength.
